(19) United States
(12) Patent Application Publication
(10) Pub. No.: US 2009/0117909 A1
(43) Pub. Date: May 7, 2009

(54) SOFT HANDOVER METHOD IN MULTIPLE WIRELESS ACCESS NETWORK ENVIRONMENT AND SERVER FOR THE SAME

(75) Inventors: Jae-ho Kim, Daejeon-city (KR); Gyung-chul Sihn, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/176,858

(22) Filed: Jul. 21, 2008

(30) Foreign Application Priority Data
Nov. 5, 2007 (KR) 10-2007-0112302

(51) Int. Cl. H04Q 7/20

(52) U.S. Cl. 455/442

(57) ABSTRACT

A soft handover method in a multiple wireless access network environment and a server for the same are provided. The present invention provides a handover method comprising: a first access point registering a user terminal with a registration server; reporting a wireless channel state of the first access point to the registration server; the first access point receiving traffic distributed from the registration server; and determining whether the handover is completed according to the distributed traffic.

### CROSS-REFERENCE TO RELATED PATENT APPLICATION

This application claims the benefit of Korean Patent Application No. 10-2007-0112302, filed on Nov. 5, 2007, in the Korean Intellectual Property Office, the disclosure of which is incorporated herein in its entirety by reference.

### BACKGROUND OF THE INVENTION

1. Field of the Invention

The present invention relates to a soft handover method in a multiple wireless access network environment and a server for the same, and more particularly, to an Inter-Radio Access Technology handover method in a network environment in which a simultaneous multiple wireless access is possible and a server for the same.

This work was partly supported by the IT R&D program of MIC/IITA [2006-S-003-02, Research on service platform for the next generation mobile comm.].

2. Description of the Related Art

Various schemes have been studied to minimize delay and packet loss which are generated during a handover procedure in a single wireless access network environment. In a MIPv6 (Mobile IP version 6), which is a typical IP mobility providing protocol, a delay of approximately several seconds is generated upon handover, and therefore, it is difficult to apply the MIPv6 in a real-time application. The handover delay of the protocol is generated in procedures such as movement sensing at an IP level, new address allocations, duplication checks, location registrations, etc.

In order to overcome such problems of the MIPv6, the working group of the International Engineering Task Force (IETF) Mobile IP Signaling and Handoff Optimization (MIPSHOP) has proposed a Hierarchical Mobile IPv6 (HMIPv6) and a Fast Handover for Mobile IPv6 (FMIPv6). The FMIPv6 uses link information which is triggered in L2 (Layer 2) in order to minimize delay of movement sensing performed by the existing MIPv6. The FMIPv6 is a technology which allows a mobile terminal to sense an L2 handover and to perform part of an L3 handover before the L2 handover is completed through a previous access router and a new access router. Even if the L2 handover is completed already, the FMIPv6 supports a real-time service by allowing the mobile terminal to continuously receive a present progressing service before registering the location of L3 by using a bidirectional tunnel between the previous router and the new router. The HMIPv6 is a protocol which extends Mobile IPv6 and IPv6 Neighbor Discovery Protocol for an in-domain mobility processing. The HMIPv6 improved a location registration speed and reduced signaling overhead between a mobile node, a Home Agent, and a correspondent node by hierarchically controlling the MIPv6 mobility.

In recent years, new wireless access technologies such as 802.11, 802.16, 802.20 and UMTS (Universal Mobile Telecommunications Systems) have been actively developed. In addition, terminals which have two or more multi-interfaces for supporting various wireless access technologies have appeared. However, the existing-Mobile IPv6 (RFC 3775)-protocol and NEMO Basic Support (RFC 3963) protocol do not support a method capable of simultaneously using the multi-interface. Therefore, MONAMI6 (Mobile Nodes and Multiple Interfaces in IPv6) working group of IETF analyzes and outlines the advantages and problems generated when simultaneously utilizing the multi-interface, and is actively conducting a study in a purpose of establishing Mobile IPv6 and NEMO Basic Support standards which can support the multi-interface.

In a simultaneous multiple wireless access network environment, various methods for shortening the delay time in a mobility processing and for solving packet loss problem have been studied.

### SUMMARY OF THE INVENTION

The present invention provides a soft handover method for minimizing handover seams generated by simultaneously using the multi-interface in a simultaneous multiple wireless access network environment and a server for the same.

According to an aspect of the present invention, there is provided a handover method comprising: a first access point registering a user terminal with a registration server; reporting a wireless channel state of the first access point to the registration server; the first access point receiving traffic distributed from the registration server; and determining whether the handover is completed according to the distributed traffic.

According to another aspect of the present invention, there is provided a server, comprising: a control unit, while receiving channel state information from a first access point, for receiving channel state information from a second access point and then receives the channel state information only from the second access point; and a traffic distribution unit which distributes traffic to each channel using the channel state information, and transmits the traffic to the first and second access point before the control unit receives the channel state information only from the second access point.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a configuration of a mobile communication network after the 3^{rd}-generation network, according to an embodiment of the present invention;

FIG. 2 illustrates a data flow occurred at handover of a user terminal supporting two multi-interfaces to a new access point, according to an embodiment of the present invention;

FIG. 3 is a flow chart illustrating a control procedure between network entities upon handover, according to an embodiment of the present invention;

FIG. 4 illustrates a wireless channel state upon handover, according to an embodiment of the present invention;

FIG. 5 is an internal block diagram illustrating the user terminal of FIG. 2, according to an embodiment of the present invention; and

FIG. 6 is an internal block diagram illustrating a MAP 33, according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as being limited to the embodiments set forth herein. Rather, these embodiments are provided so that this disclosure will be thorough and complete, and will fully convey the scope of the invention to those skilled in the art.

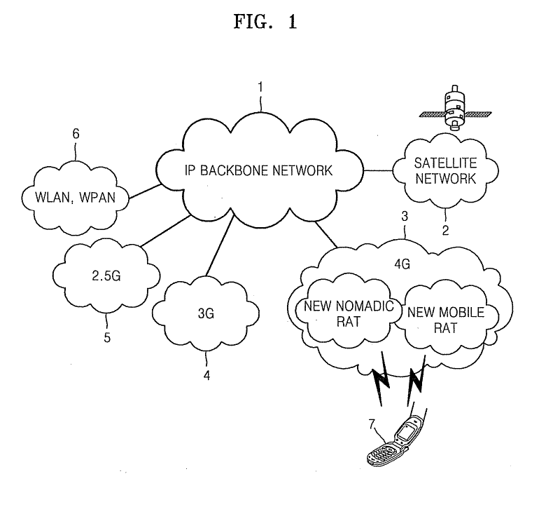

FIG. 1 illustrates a configuration of a mobile communication network after the 3^{rd} generation network, according to an embodiment of the present invention. In the network shown, an IP backbone network 1 is connected to a satellite network 2, a 4^{th} generation network 3, a 3^{rd} generation network 4, a 2.5^{th} generation network 5, and a wireless local-area network (WLAN or WPAN) 6 etc. A user terminal 7 has various wireless access interfaces, and more particularly, in a next generation 4G mobile communication network 3, a new mobile RAT (New Mobile Radio Access Technology) which provides a high-speed mobility coexists with a new Nomadic RAT which provides a high data rate.

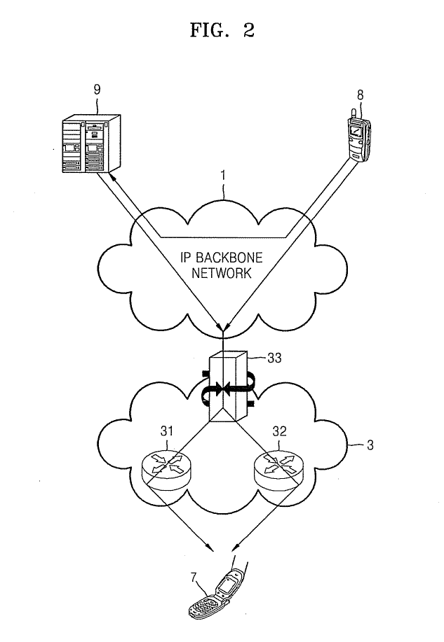

FIG. 2 illustrates a data flow occurred at handover of a user terminal supporting two multi-interfaces to a new access point, according to an embodiment of the present invention

When the user terminal 7 is handovered from an existing access point (RAT_{A}_{_{—}}AP) 31 to a new access point (RAT_{B}_{_{—}}AP) 32 while the user terminal 7 communicates with the correspondent node 8, the user terminal 7 exists in an overlapping domain between the two access points 31 and 32.

FIG. 5 is an internal block diagram illustrating the user terminal 7, according to an embodiment of the present invention.

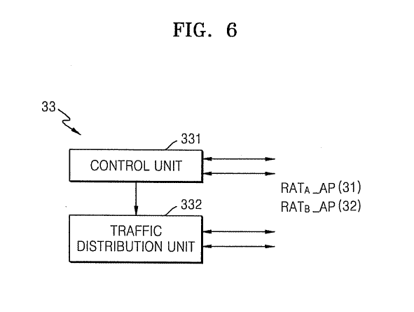

As shown in FIG. 6, the user terminal 7 comprises a control unit 71, a RAT_{A}_{_{—}}AP interface (IF) 72, and a RAT_{B}_{_{—}}AP interface (IF) 73.

The control unit 71 is multi-connected via the RAT_{A}_{_{—}}AP interface (IF) 72 and the RAT_{B}_{_{—}}AP interface (IF) 73 to the RAT_{A}_{_{—}}AP 31 and the RAT_{B}_{_{—}}AP 32 respectively so that it can be registered on a mobile anchor point (MAP) 33. Furthermore, the control unit 71 simultaneously receives traffic transmitted via each of the access points 31 and 32 from the MAP 33.

The MAP 33 conceptually serves as a home agent (HA), and handles handover based on the terminal movement between access points within an MAP domain, whereby the movement within the same MAP domain is concealed from a correspondent node 8 or the HA 9. Herein, the HA 9 has registration information for the mobile terminals 7 and 8.

FIG. 6 is an internal block diagram illustrating the MAP 33, according to an embodiment of the present invention. The MAP 33 comprises a control unit 331 and a traffic distribution unit 332.

The control unit 331 registers the user terminal 7 according to registration information which is received from each of the access points 31 and 32, and outputs channel state information which is received from each of the access points 31 and 32 to the traffic distribution unit 332.

The traffic distribution unit 332 dynamically distributes traffic according to the wireless channel state of each of the access points 31 and 32 when simultaneously transmitting the traffic to each of the access points 31 and 32 according to the channel state information.

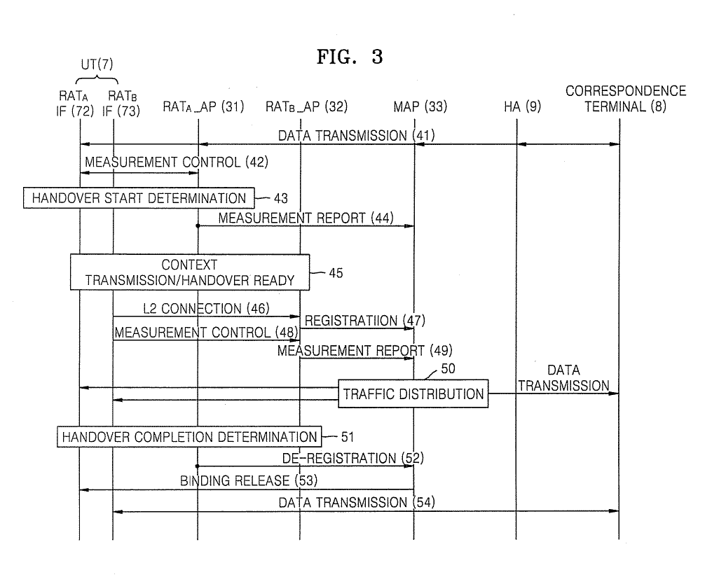

FIG. 3 is a flow chart illustrating a control procedure between network entities upon handover, according to an embodiment of the present invention. As illustrated in FIG. 3, the user terminal 7 is handovered via the RAT_{A} AP IF 72 and the RAT_{B} AP IF 73 from the RAT_{A}_{_{—}}AP 31 to the RAT_{B}_{_{—}}AP 32. Before the handover, user data is transmitted from the correspondent node 8 to the HA 9 according to an IP routing mechanism, and the HA 9 tunnels the corresponding data to the MAP 33. The data received at the MAP 33 is transmitted via the RAT_{A}_{_{—}}AP 31 to the user terminal 7 according to an intra-domain mobility management protocol of the corresponding access system (STEP 41).

The user terminal 7 and the RAT_{A}_{_{—}}AP 31 determine a time point when the handover should be started and a target access point (Target AP) periodically or through an event-based wireless channel measurement control (STEP 43). When the handover start time point is determined, the RAT_{A}_{_{—}}AP 31 reports a wireless channel state of RAT_{A} to the MAP 33 (STEP 44). Next, the user terminal 7, the RAT_{A}_{_{—}}AP 31, and the RAT_{B}_{_{—}}AP 32 transfer the context to each other to prepare the handover (STEP 45), wherein the context is an information for address or protocol which is possessed by the user terminal 7, and is usually transferred to a target AP, the RAT_{B}_{_{—}}AP 32, by the RAT_{A}_{_{—AP 31.}}

Next, the RAT_{B} IF 73 of the user terminal 7 is activated and establishes a layer 2 connection (L2 connection) with the RAT_{B}_{_{—}}AP 32 (STEP 46). When the layer 2 connection is completed, the RAT_{B}_{_{—}}AP 32 registers the user terminal 7 with the MAP 33 (STEP 47). The wireless channel state of the RAT_{B} is measured periodically or by an event-based scheme (STEP 48) in the RAT_{B}_{_{—}}AP 32, and is periodically reported to the MAP 33 (STEP 49). The MAP 33 distributes the traffic to the multiple registered user interfaces 72 and 73 using a Weighted Round-Robin scheduling algorithm based on the reported channel information (STEP 50). The user terminal 7, the RAT_{A}_{_{—}}AP 31 or the RAT_{B}_{_{—}}AP 32 determines a preferred AP by estimating the channel state using the distributed traffic. In addition, according to each RAT channel state, just when the user terminal 7 is deviating from an overlapping domain or when the corresponding channel state value is higher than a threshold value, the handover completion is determined (STEP 51). The RAT_{A}_{_{—}}AP 31, in which the connection with the user terminal is disconnected, transmits a de-registration message to the MAP 33 (STEP 52). The MAP 33 which received the de-registration message releases binding to the RAT_{A} IF 72 (STEP 53). The user terminal 7 communicates via the RAT_{B} IF 73 and RAT_{B}_{_{—}}AP 32 to the correspondent node 9 (STEP 54).

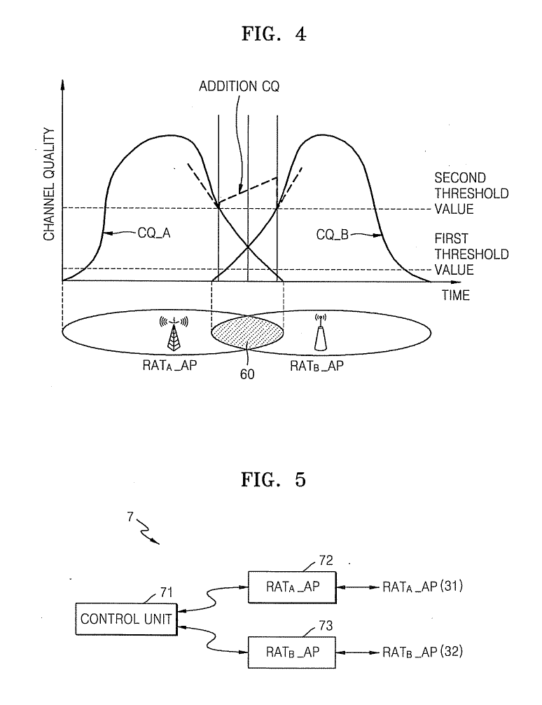

FIG. 4 illustrates a wireless channel state upon handover, according to an embodiment of the present invention.

In FIG. 4, x-axis is a time-axis and y-axis indicates the channel quality. Curves CQ_A and CQ_B illustrate the wireless channel quality of each AP, which is measured on the time-basis, when the user terminal 7 is moved from the RAT_{A}_{_{—}}AP 31 to the RAT_{B}_{_{—}}AP 32. The handover is performed in an overlapping domain 60, and data distribution to the multi-interface which is simultaneously accessed according to the quality and the preference of each channel within the overlapping domain is accomplished.

Assuming that a specific technology preference is Wᵢ, the sum Wₜ of each wireless access technology preference to which the user terminal is accessible is 1. When CQᵢ denotes wireless quality of each channel, a CQᵢ value is determined by the following formula:

$$\{ \begin{matrix}0 \leq {CQ}_{i} \leq 1 & \\ {CQ}_{i} = 0 , & {CQ}_{i} < first threshold value \\ {CQ}_{i} = 1 , & {CQ}_{i} > second threshold value\end{matrix} \qquad ( 1 )$$

If Dₜ is a total sum of the product of each of the quality value of each wireless access channel and the preference to the wireless access channel, a distribution ratio Dᵢ to the wireless access channel is derived by the following formula:

$$\begin{matrix}{D}_{t} = {\sum }_{i = 1}^{n} ( {W}_{i} \times {CQ}_{i} ) & ( 2 ) \\ {D}_{i} = \frac{{W}_{i} \times {CQ}_{i}}{{D}_{t}} & \end{matrix}$$

A WRR scheduler distributes the traffic to each channel using the Dᵢ value.

According to the present invention, the data distribution is accomplished according to the quality of each channel and the preference to a wireless access technology upon handover in a simultaneous multi-interface network environment, wherein a stable and seamless service is provided with a user. In addition, ping-pong problems resulting from the user's frequent movement in an overlapping domain between two APs can be solved.

The present invention has been particularly shown and described with reference to exemplary embodiments thereof. Herein, specific terms are used, but they are used only for the purpose of illustrating the present invention, and is not used to limit their meanings and the scope of the present invention defined the following claims. Therefore, it will be understood by those of ordinary skill in the art that various changes in form and further equivalent embodiments may be made. Accordingly, the true technical scope of the present invention should be defined by the technical spirit of the following claims.

What is claimed is:

1. A handover method comprising:
a first access point registering a user terminal with a registration server;
reporting a wireless channel state of the first access point to the registration server;
the first access point receiving traffic distributed from the registration server; and
determining whether the handover is completed according to the distributed traffic.

2. The method of claim 1, further comprising before the registering the user terminal:
a second access point performing a wireless channel measurement control on the user terminal; and
determining a time point when the handover is to be started using a result of the wireless channel measurement control.

3. The method of claim 2, further comprising:
the first access point communicating context to the user terminal and the second access point each other.

4. The method of claim 1, wherein the wireless channel state of the first access point is measured periodically or by an event-based scheme.

5. The method of claim 1, wherein the traffic distribution is performed according to a weight round robin (WRR) scheduling algorithm.

6. The method of claim 5, wherein the WRR scheduling algorithm determines traffic which is distributed to an i-th channel according to a ratio in which a multiplication of channel quality value of the i-th channel by a wireless communication technology preference occupies with respect to an entire channel.

7. The method of claim 6, wherein the channel quality value of the i-th channel is set to 0 if the channel quality value of the i-th channel is lower than a first threshold value, set to 1 if higher than a second threshold value, and used without a change if between the first and second threshold values.

8. The method of claim 1, wherein the determining whether the handover is completed is performed when the user terminal is deviating from an overlapping domain of the first and second access points, or when a channel state value with a preferred access point is higher than a threshold value.

9. A server, comprising:
a control unit, while receiving channel state information from a first access point, for receiving channel state information from a second access point and then receives the channel state information only from the second access point; and
a traffic distribution unit which distributes traffic to each channel using the channel state information, and transmits the traffic to the first and second access point before the control unit receives the channel state information only from the second access point.

10. The server of claim 9, wherein the traffic distribution unit distributes according to a weight round robin (WRR) scheduling algorithm.

11. The server of claim 10, wherein the WRR scheduling algorithm determines a traffic which is distributed to an i-th channel according to a ratio in which a multiplication of channel quality value of the i-th channel by a wireless communication technology preference occupies with respect to an entire channel

12. The server of claim 11, wherein channel quality value of the i-th channel is set to 0 if the channel quality value of the i-th channel is lower than a first threshold value, set to 1 if higher than a second threshold value, and used without a change if between the first and second threshold values.

13. The server of claim 9, wherein the channel state information is received periodically or by an event-based scheme from the first access point or the second access point.
